(19) United States
(12) Patent Application Publication
(10) Pub. No.: US 2026/0009735 A1
(43) Pub. Date: Jan. 8, 2026

(54) Apparatus for Inspecting Unit Cell

(71) Applicant: LG Energy Solution, Ltd., Seoul (KR)

(72) Inventors: Jong Ha Kwon, Daejeon (KR); Jong Myung Lee, Daejeon (KR); Kwan Woo Lee, Daejeon (KR); Hoon Seok Kang, Daejeon (KR); Hyo Sun Choi, Daejeon (KR)

(73) Assignee: LG Energy Solution, Ltd., Seoul (KR)

(21) Appl. No.: 18/838,768

(22) PCT Filed: Feb. 15, 2023
(86) PCT No.: PCT/KR2023/002218

§ 371 Date: Aug. 15, 2024

(30) Foreign Application Priority Data
Feb. 16, 2022 (KR) 10-2022-0020455
Feb. 14, 2023 (KR) 10-2023-0019638

(51) Int. Cl. G01N 21/88; G01N 21/84; H01M 10/42

(52) U.S. Cl. CPC G01N 21/8806; H01M 10/4285; G01N 2021/845; G01N 2021/8809

(57) ABSTRACT

An apparatus for inspecting a unit cell includes a transfer part to transfer a plurality of unit cells in a predetermined transfer direction, a plurality of transfer rollers arranged in the transfer direction, and an optical inspection part to optically sense a unit cell to be inspected that is disposed at a predetermined inspection position. Each of the unit cells may further include an electrode tab extending from the electrode and exposed to the outside of a separator of each of the unit cells. The optical inspection part may be provided to set, as a region of interest (ROI), a region in which at least a portion of the electrode tab is disposed at the inspection position, and an adjacent transfer roller that is disposed to be adjacent to the region of interest may be provided to non-overlap the region of interest.

### CROSS-REFERENCE TO RELATED APPLICATION

The present application is a national stage entry under 35 U.S.C. § 371 of International Application No. PCT/KR2023/002218, filed on Feb. 15, 2023, which claims priority from Korean Patent Application Nos. 10-2022-0020455, Feb. 16, 2022, filed on and 10-2023-0019638, filed on Feb. 14, 2023, all of which are hereby incorporated by reference.

### TECHNICAL FIELD

The present disclosure relates to an apparatus for inspecting a unit cell.

### BACKGROUND ART

In general, secondary batteries refer to batteries, which are chargeable and dischargeable unlike non-rechargeable primary batteries, and are widely used in electronic devices such as mobile phones, notebook computers and camcorders, electric vehicles, or the like. In particular, lithium secondary batteries have a larger capacity and a higher energy density than nickel-cadmium batteries or nickel-hydrogen batteries, and thus utilization thereof is on a rapidly increasing trend.

According to the shape of a battery case, the secondary batteries may be classified into a cylindrical type battery and a prismatic type battery, each of which has an electrode assembly embedded in a cylindrical or prismatic metal can, a pouch type battery having an electrode assembly embedded in a pouch type case made of an aluminum laminate sheet, and so on.

FIG. 1 is a view illustrating an example of a pouch type secondary battery. A pouch type secondary battery 1 includes an electrode assembly 2, in which an electrode and a separator are provided to be alternately stacked, and a pouch 20 in which the electrode assembly 2 is accommodated. Each of electrode tabs 15 may be connected to the electrode of the electrode assembly 2. The electrode tabs 15 may be welded to each other in a predetermined area and then connected to an electrode lead 17. The pouch 20 includes a cup part 21 having a recessed shape for accommodating the electrode assembly 2. The cup part 21 of the pouch 20 may be provided in one or two. FIG. 1 illustrates an example of the pouch 20 including a left cup part and a right cup part. A circumferential part 23 (terrace) is formed around a circumference of the cup part 21 by sealing.

It may be optically inspected during manufacturing of the electrode assembly 2 whether a unit cell constituting the electrode assembly 2 is normal (e.g., whether the electrode tab of the unit cell is folded). This inspection may be performed by photographing the unit cell and then analyzing a photographed image. However, when an object (e.g., the electrode tab of the unit cell) to be inspected for abnormality is blocked by other objects during obtaining of the photographed image of the unit cell, it may be difficult to analyze the obtained image to determine whether there is an abnormality. For example, when a roller disposed at a lower side of the unit cell for transfer of the unit cell blocks the electrode tab of the unit cell, it may be difficult to accurately obtain an image of the electrode tab and accordingly, it may be difficult to properly determine through the obtained image whether the electrode tab is normal.

### DISCLOSURE OF THE INVENTION

### Technical Problem

An object of the present invention is to provide an apparatus for inspecting a unit cell, which is capable of preventing an object to be inspected of the unit cell from being photographed in a state of being blocked by other objects during obtaining of a photographed image of the unit cell for inspection of the unit cell, to accurately determine whether the object to be inspected is normal.

### Technical Solution

In an embodiment, an apparatus for inspecting a unit cell may include a transfer part, which is provided to transfer a plurality of unit cells, each of which is provided with an electrode, in a predetermined transfer direction and includes a plurality of transfer rollers arranged in the transfer direction, and an optical inspection part which is provided to optically sense a unit cell to be inspected that is a unit cell disposed at a predetermined inspection position among the plurality of unit cells transferred by the transfer part. Each of the unit cells may further include an electrode tab extending from the electrode and exposed to an outside of a separator provided in each of the unit cells, the optical inspection part may be provided to set, as a region of interest (ROI), a region including a region in which at least a portion of the electrode tab is disposed at the inspection position, and an adjacent transfer roller that is a transfer roller disposed to be adjacent to the region of interest among the plurality of transfer rollers may be provided to non-overlap the region of interest.

In another embodiment, the region of interest may be set based on a region, in which the electrode tab is disposed at the inspection position during normal transfer of the unit cell, and a region in which the electrode tab is disposed at the inspection position during a misaligned transfer of the unit cell.

In still another embodiment, the region of interest may be set to include a region, which extends from a distal end of the separator, at which the electrode tab starts to be exposed when the electrode tab is disposed in a longitudinal direction, which is particular to the transfer direction, of the adjacent transfer roller, to the outside of the separator by a first distance in the longitudinal direction, and a region which extends from the distal end to an inside of the separator by a second distance in a direction opposite to the longitudinal direction.

In still another embodiment, the first distance may be a length defined in the longitudinal direction and be set based on an exposure length of the electrode tab exposed from the distal end of the separator to the outside of the separator.

In still another embodiment, the first distance may be 15 mm to 30 mm.

In still another embodiment, the second distance may be a length defined in the longitudinal direction and be set based on an exposure length of the electrode tab exposed from the distal end of the separator to the outside of the separator, and a predetermined extra distance.

In still another embodiment, the second distance may be 15 mm to 30 mm.

In still another embodiment, the first distance may be less than or equal to the second distance.

In still another embodiment, the adjacent transfer roller may be provided to have a length that does not invade the region of interest.

In still another embodiment, the optical inspection part may include a lamp, which is provided to emit light toward the unit cell to be inspected and disposed at an upper side of the unit cell to be inspected, and a camera which is provided to photograph the unit cell to be inspected in a state in which the light is emitted by the lamp, and disposed at a lower side of the unit cell to be inspected.

In still another embodiment, the optical inspection part may further include a reflecting plate that changes a photographing path of the camera to a direction perpendicular to the photographing path.

In still another embodiment, the electrode tab may include a positive electrode tab and a negative electrode tab extending from a positive electrode and a negative electrode, which are one of the electrodes and the other thereof, in the longitudinal direction, which perpendicularly crosses the transfer direction, of the adjacent transfer roller and a direction opposite thereto, respectively. The optical inspection part may include a positive electrode tab inspection part, which optically inspects the positive electrode tab by setting, as the region of interest, a region including a region in which at least a portion of the positive electrode tab is disposed at the inspection position, and a negative electrode tab inspection part which optically inspects the negative electrode tab by setting, as the region of interest, a region including a region in which at least a portion of the negative electrode tab is disposed at the inspection position.

In still another embodiment, the adjacent transfer roller may be disposed to at least partially overlap the unit cell to be inspected that is disposed at the inspection position.

In still another embodiment, a gap between the adjacent transfer roller and another transfer roller disposed to be most adjacent to the adjacent transfer roller may be smaller than a width of the unit cell defined in the transfer direction.

### Advantageous Effects

According to an aspect of the present invention, as the adjacent transfer roller does not invade the region of interest, the problem may be solved in which due to the interference of the transfer roller, the optical inspection part is incapable of determining or incorrectly determines whether the electrode tab is normal, when processing the region of interest of the obtained image.

### BRIEF DESCRIPTION OF THE DRAWINGS

FIG. 1 is an exploded perspective view illustrating an example of a pouch type secondary battery.

FIG. 2 is a side elevation view illustrating an apparatus for inspecting a unit cell according to Embodiment 1 of the present invention.

FIG. 3 is a plan view of the inspecting apparatus in FIG. 2 when viewed from an upper side.

FIG. 4 is a plan view of a unit cell to be inspected disposed at an inspection position when viewed from a bottom, and is a view illustrating an example of a case in which a transfer roller blocks an electrode tab in a region of interest.

FIG. 5 is a plan view of a unit cell to be inspected disposed at an inspection position when viewed from a bottom, and is a view illustrating an example of a case in which a transfer roller does not block an electrode tab in a region of interest.

FIG. 6 is a plan view of a unit cell to be inspected disposed at an inspection position when viewed from a bottom, and is a view illustrating an example of a case in which a separating film is meanderingly transferred.

FIG. 7 is a schematic side elevation view specifically illustrating an optical inspection part of the inspecting apparatus in FIG. 2.

FIG. 8 is a schematic side elevation view illustrating an apparatus for inspecting a unit cell according to Embodiment 2 of the present invention.

### DETAILED DESCRIPTION

Hereinafter, preferred embodiments of the present invention will be described in detail with reference to the accompanying drawings to enable those skilled in the art to which the present invention pertains to easily carry out the present invention. The present invention may, however, be embodied in different forms and should not be construed as limited by the embodiments set forth herein.

The parts unrelated to the description, or the detailed descriptions of related well-known art that may unnecessarily obscure subject matters of the present invention, will be ruled out in order to clearly describe the present invention. Like reference numerals refer to like elements throughout the whole specification.

Moreover, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

### Embodiment 1

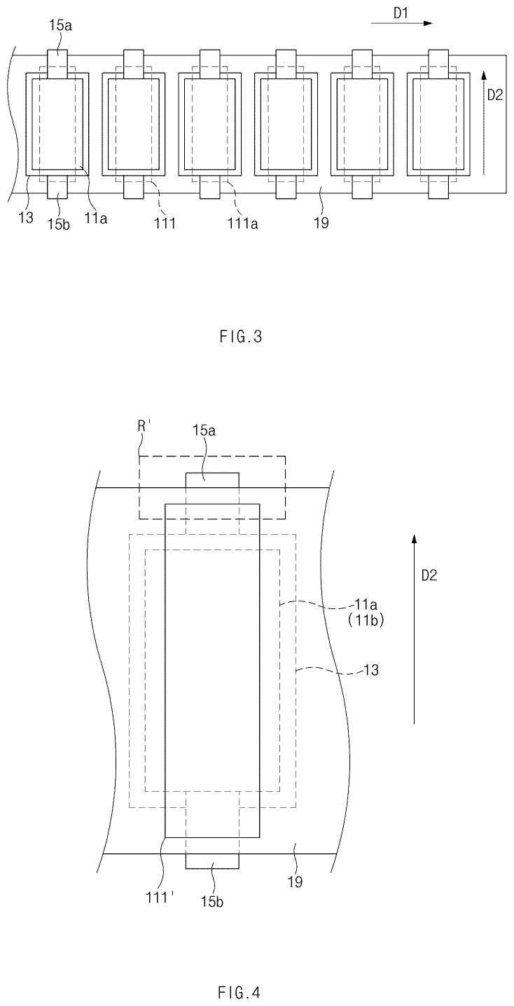

FIG. 2 is a view illustrating an apparatus for inspecting a unit cell according to Embodiment 1 of the present invention. FIG. 3 is a plan view of the inspecting apparatus in FIG. 2 when viewed from an upper side. The apparatus according to Embodiment 1 of the present invention is an apparatus for inspecting a unit cell 10, and, for example, may be an apparatus for inspecting electrode tabs 15a and 15b of the unit cell 10. The inspecting apparatus according to this embodiment may include a transfer part 110 for transferring the unit cell 10, and an optical inspection part 130 for inspecting the unit cell 10.

The transfer part 110 may be provided to transfer the unit cells 10 in a predetermined transfer direction D1. For example, the transfer part 110 may include a belt conveyor (not shown) for transferring the unit cells 10. The belt conveyor may include a driving roller (not shown) that supplies driving power, and an annular belt (not shown) that is circulated by the driving roller. The unit cells 10 may be seated on and transferred by a belt circulated by the driving roller.

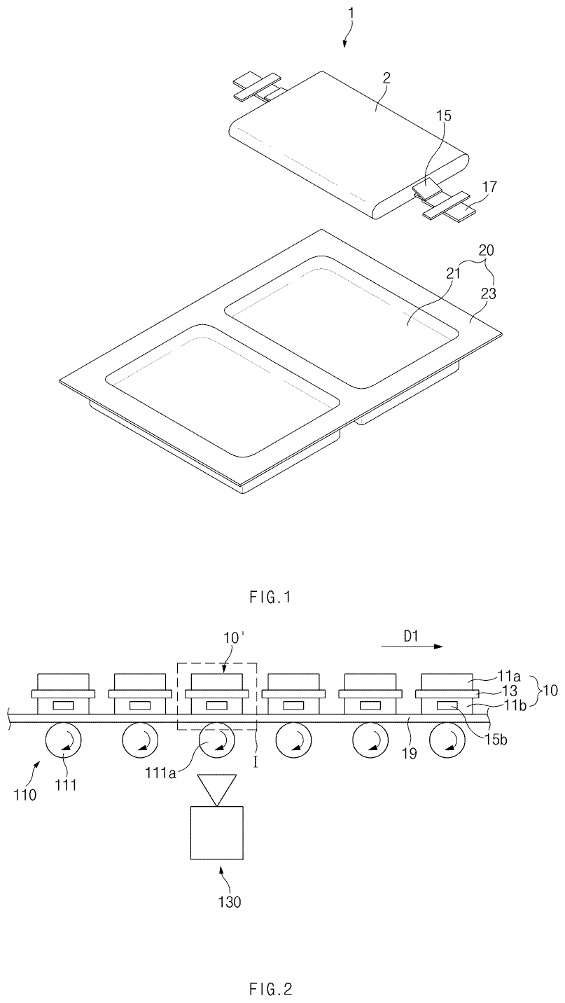

As illustrated in FIG. 2, the transfer part 110 may be implemented in a manner of transferring a separating film 19. The electrode assembly 2 (see FIG. 1) constituting the battery may be configured in various types. For example, the electrode assembly 2 may be configured in a stack and folding type. The stack and folding type electrode assembly 2 may be manufactured by using the separating film 19 to fold unit cells 10 (full-cells or bi-cells) that are provided so that electrodes 11a and 11b and a separator 13 are stacked according to a certain rule. The transfer part 110 may transfer the separating film 19 to transfer the unit cells 10 seated on the separating film 19 (see FIG. 3). To this end, the transfer part 110 may include the driving roller (not shown) for unwinding the separating film 19 from a roller (not shown) on which the separating film 19 is wound. As the separating film 19 also serves as a separator, hereinafter both the separating film 19 and the separator 13 included in the unit cell 10 may be referred to as separators. For reference, the inspecting apparatus according to this embodiment may be disposed in front of a folding device or as a portion of the folding device.

The transfer part 110 may include a plurality of transfer rollers 111 arranged in a transfer direction D1. The transfer rollers 111 may support the separating film 19 during the transfer of the separating film 19. To this end, the transfer rollers 111 may be disposed at a lower side of the separating film 19. The transfer rollers 111 may be idle rollers to which driving power is not supplied.

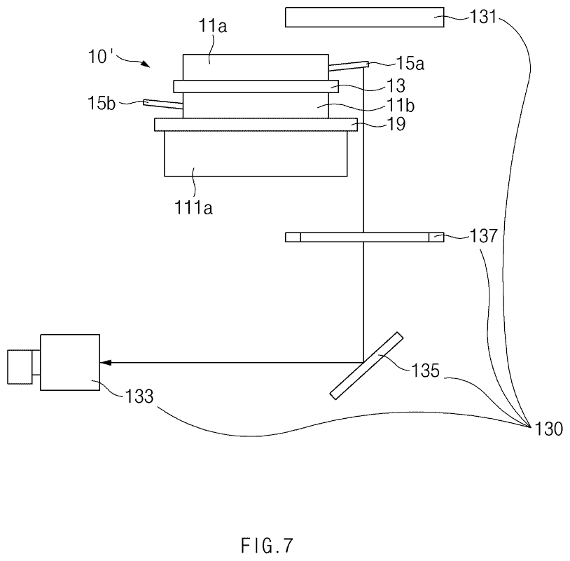

The optical inspection part 130 may be provided to optically sense a unit cell 10′ (see FIG. 2) to be inspected. The optical inspection part 130 may be provided to capture and process an image of the unit cell 10′ to be inspected so as to inspect whether the unit cell 10′ to be inspected is normal. To this end, the optical inspection part 130 may include a camera 133 (see FIG. 7), for example, a CCD camera, for photographing the unit cell 10′ to be inspected. Here, the unit cell 10′ to be inspected may be a unit cell 10 that is disposed at a predetermined inspection position I (see FIG. 2) among the plurality of unit cells 10 transferred by the transfer part 110. The inspection position I may be a position at which the unit cell 10 is photographable by the camera 133 of the optical inspection part 130.

The optical inspection part 130 may set, as a region of interest (ROI) R (FIG. 5), a region including a region in which the electrode tabs 15a and 15b are disposed at the inspection position I. The region of interest R may be a region, which requires processing (image processing) for determining whether there is an abnormality, of the image photographed by the camera 133 of the optical inspection part 130. As the optical inspection part 130 sets, as the region of interest R, the region including the region in which the electrode tabs 15a and 15b are disposed at the inspection position I, the electrode tabs 15a and 15b may be inspected for an abnormality. When only a portion of each of the electrode tabs 15a and 15b is available for determining whether there is an abnormality, the region of interest R may be set to include a region in which the portion of each of the electrode tabs 15a and 15b is disposed. Here, the electrode tabs 15a and 15b may extend from the electrodes 11a and 11b, respectively, and be provided in the unit cell 10 to be exposed to the outside of the separator 13 that separates the electrodes 11a and 11b from each other. For example, FIG. 3 illustrates an example of the electrode tabs 15a and 15b that are exposed to the outside of the separator 13 of the unit cell 10 and also exposed to the outside of the separating film 19. For reference, as an example in FIG. 5 to be described later, the region of interest R is set to include a portion of one electrode tab 15a of the two electrode tabs 15a and 15b.

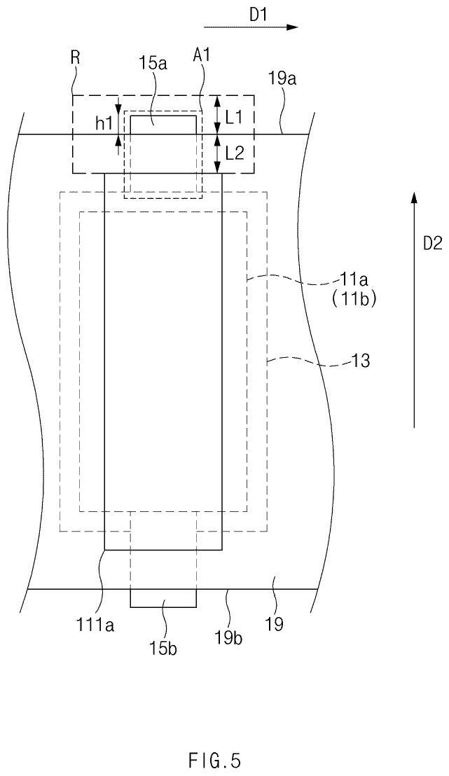

When the optical inspection part 130 photographs the unit cell 10′ to be inspected, a transfer roller 111′ of the transfer part 110 may interfere with the photographing of the optical inspection part 130. For example, the optical inspection part 130 may photograph the unit cell 10′ to be inspected at a lower side of the unit cell 10′ to be inspected, and, as illustrated in FIG. 4, when the transfer roller 111′ is provided to be elongated in a longitudinal direction D2 of the transfer roller 111′, the transfer roller 111′ may block a portion of the electrode tab 15a in a region of interest R′ during the photographing of the optical inspection part 130. Each of the electrode tabs 15a and 15b may be folded inward to the inside of the separating film 19 for reasons such as collision with other portions during the transfer, and when the transfer roller 111′ blocks the electrode tab 15a in the region of interest R′, it may be difficult for the optical inspection part 130 to properly obtain the image of the electrode tab 15a folded inward to the inside of the separating film 19. These problems caused by blocking (or overlapping) may further occur during the meandering transfer to be described later. For example, this is because a degree to which the transfer roller blocks the region of interest may increase due to the meandering transfer compared to a case of the normal transfer. FIG. 4 is a view of the unit cell to be inspected disposed at the inspection position when viewed from a bottom, and is a view illustrating an example of a case in which the transfer roller blocks the electrode tab in the region of interest.

In the apparatus for inspecting the unit cell according to this embodiment, in order to solve the above problems, an adjacent transfer roller 111a that is the transfer roller 111, which is disposed to be adjacent to the region of interest R among the transfer rollers 111, may be provided to non-overlap the region of interest R as illustrated in FIG. 5. For example, the adjacent transfer roller 111a may be provided to have a length that does not invade the region of interest R. The length of the transfer roller 111a in FIG. 5 may be less than a length of the transfer roller 111′ in FIG. 4. For example, when the electrode tabs 15a and 15b are provided to be exposed in the longitudinal direction D2 of the adjacent transfer roller 111a and a direction opposite thereto, respectively (and when two regions of interest are set to correspond to the electrode tabs, respectively, as in Embodiment 2 to be described later), the length of the adjacent transfer roller 111a in FIG. 5 may be less than a length of the transfer roller 111′ in FIG. 4 by 60 mm. FIG. 5 is a view of a unit cell to be inspected disposed at an inspection position when viewed from a bottom, and is a view illustrating an example of a case in which a transfer roller does not block an electrode tab in a region of interest. For reference, whether to overlap may be determined in a stacking direction of the electrode and the separator or a direction perpendicularly crossing the separating film (an upward and downward direction in FIG. 2).

As the adjacent transfer roller 111a does not invade the region of interest R, the apparatus for inspecting the unit cell according to this embodiment may solve the problem that due to an interference of the transfer roller 111, the optical inspection part 130 is incapable of determining or incorrectly determines whether the electrode tabs 15a and 15b are normal, when processing the region of interest R of the obtained image.

In this embodiment, the adjacent transfer roller 111a may be disposed to at least partially overlap the unit cell 10′ to be inspected, which is disposed at the inspection position I, in order to solve the following problems. FIG. 5 illustrates an example of the adjacent transfer roller 111a that partially overlaps the electrodes 11a and 11b and the separator 13 of the unit cell 10′ to be inspected.

The separating film 19 is prone to vertically sagging downward during the process. Pulling of the separating film may be interrupted during a folding process in the manufacturing of the stack and folding type electrode assembly (e.g., when one electrode assembly is completed and then folding of a subsequent electrode assembly is prepared). When this interruption occurs, tension applied to the separating film is decreased and thus, the separating film is prone to sagging downward. Here, when the supply of the separating film continues in the upstream of the inspecting apparatus, this sagging may further occur. In addition, when the unit cell is disposed on the separating film, the sagging of the separating film may further occur due to the weight of the unit cell.

When this sagging occurs, the photographed image may be distorted so that an object to be inspected is not accurately inspected. In addition, deformation such as wrinkles, may occur in the electrode assembly. In the photographed image, the separator may appear to be a bright color, and the electrode may appear to be a dark color. Thus, when a change from the dark color to the bright color is recognized (to this end, a trigger sensor is generally used), this unit cell may be recognized as passing (or arriving) and starting the photographing (after a predetermined time) may be considered. However, when the sagging of the separating film occurs, a problem may occur also in this recognition to lead to a problem of a time point of starting the photographing.

In order to solve these problems, i.e., in order to prevent the sagging of the separating film 19, the adjacent transfer roller 111a according of this embodiment may be provided to be disposed to at least partially overlap the unit cell 10′ to be inspected to support the separating film 19 as illustrated in FIG. 5. Alternatively, a gap between the transfer rollers 111 may be set to be small in order to support the separating film 19. For example, a gap between the adjacent transfer roller 111a and another transfer roller 111 (or another adjacent transfer roller) disposed to be most adjacent to the adjacent transfer roller 111a may be smaller than a width of the unit cell defined in the transfer direction D1 (e.g., a width in a left and right direction of the electrode in FIG. 5). Accordingly, an area of the separating film 19, which is not supported by the transfer roller, may be minimized. Alternatively, in order to support the separating film 19, the adjacent transfer roller 111a may have the maximum length (see FIG. 5) non-overlapping the region of interest (or spaced a predetermined extra distance from the region of interest).

The apparatus for inspecting the unit cell according to this embodiment may achieve both the prevention of the sagging of the separating film and the prevention of the interference of the adjacent transfer roller to the photographed image as described above.

The region of interest R may be set as follows.

First, the region of interest R may be set in consideration of an area A1 in which the electrode tab 15a is disposed at the inspection position I (see FIG. 2) during normal transfer of the unit cell 10 as illustrated in FIG. 5. The normal transfer refers to a case in which the separating film 19 is transferred along a predetermined path, and may be contrasted with meandering transfer that is a case in which the separating film 19 is transferred to deviate from the predetermined path. As illustrated in FIG. 5, the electrode tab 15a may be disposed at the area A1 of the inspection position I during the normal transfer.

However, the optical inspection part 130 may determine, as an occurrence of abnormality in the electrode tab 15a, cases such as a case, in which a portion of the electrode tab 15a, which is exposed to the outside of the separating film 19, is folded to the outside of the separating film 19, or a case in which the portion of the electrode tab 15a, which is exposed to the outside of the separating film 19, is folded inward to the inside of the separating film 19. For such a determination, the region of interest R may be set to include both a region, in which the portion of the electrode tab 15a, which is exposed to the outside of the separating film 19, is disposed, and a region in which, when the portion of the electrode tab 15a, which is exposed to the outside of the separating film 19, is folded inward to the inside of the separating film 19, the portion folded inward is disposed.

Second, the region of interest R may be set in consideration of at least one of a first distance L1 or a second distance L2, which will be described later. When the electrode tab 15a is disposed in a longitudinal direction D2 of the adjacent transfer roller 111a, which perpendicularly crosses the transfer direction D1 of the unit cell 10, the electrode tab 15a starts to be exposed from a distal end 19a of the separating film 19 in the longitudinal direction D2 to the outside of the separating film 19. The first distance L1 is a distance set from the distal end 19a of the separating film 19 in the longitudinal direction D2 as described above, and the second distance L2 is a distance set from the distal end 19a of the separating film 19 in a direction opposite to the longitudinal direction D2. The region of interest R may be set to include a region, which extends from the distal end 19a of the separating film 19 to the outside of the separating film 19 by the first distance L1, and a region which extends from the distal end 19a of the separating film 19 to the inside of the separating film 19 by the second distance L2.

The first distance L1 may be set based on an exposure length h1 of the electrode tab 15a exposed from the distal end 19a of the separating film 19 to the outside of the separating film 19. The exposure length h1 of the electrode tab 15a may be a length defined in the longitudinal direction D2. For example, the first distance L1 may be set to be the same as the exposure length h1 of the electrode tab 15a so that the exposed portion of the electrode tab 15a, which is disposed at the inspection position I (see FIG. 2), is included in the region of interest R. Alternatively, considering that the electrode tab 15a may be folded or disposed to be twisted during the meandering transfer or that an extra region may be necessary during the image processing, the first distance L1 may be set to be greater than the exposure length h1 as illustrated in FIG. 5, i.e., further considering a predetermined extra distance. For example, when the exposure length h1 of the electrode tab 15a is 15 mm, the first distance L1 may be set to 15 mm to 30 mm.

The second distance L2 may be set based on the exposure length h1 of the electrode tab 15a, which is exposed from the distal end 19a of the separating film 19 to the outside of the separating film 19, and the predetermined extra distance. When the exposed portion of the electrode tab 15a is entirely folded inward to the inside of the separating film 19, the exposed portion of the electrode tab 15a may be disposed inside the separating film 19 from the distal end 19a of the separating film 19 by the exposure length h1. So as for all cases including even this case to be inspected, the second distance L2 may be set in consideration of the exposure length h1 of the electrode tab 15a. Considering the twisting of the electrode tab 15a, the extra region during the image processing, or the like, the second distance L2 may be set in consideration of both the exposure length h1 of the electrode tab 15a and the predetermined extra distance. For example, when the exposure length h1 of the electrode tab 15a is 15 mm, the second distance L2 may be set to 15 mm to 30 mm. The second distance L2 may be greater than or equal to the first distance L1.

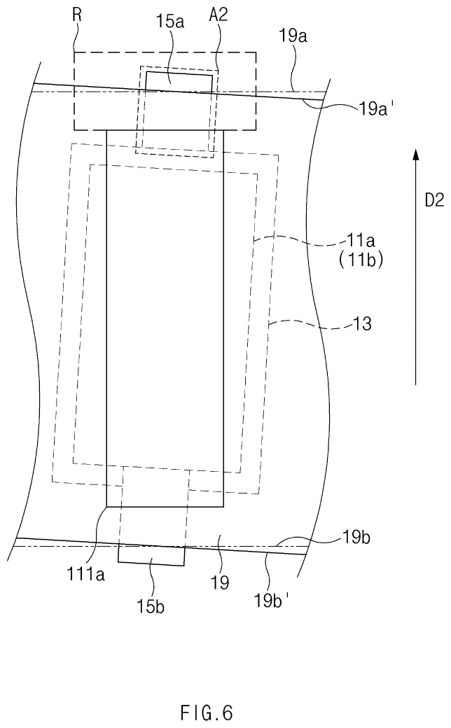

Third, the region of interest R may be set based on a region, in which the electrode tab 15a is disposed at the inspection position I during the normal transfer of the unit cell 10, and a region in which the electrode tab 15a is disposed at the inspection position I during the meandering transfer of the unit cell 10. As illustrated in FIG. 6, the separating film 19 may be transferred in a state of being twisted for several reasons during the transfer. In FIG. 6, the reference symbol 19a refers to the distal end of the separating film 19 during the normal transfer, and the reference symbol 19a′ refers to the distal end of the separating film 19 during the meandering transfer. In order to inspect whether the electrode tab 15a is normal even when the position of the electrode tab 15a is changed due to this twisting, the region of interest R may be set in consideration of both a position of the electrode tab 15a (see A1 in FIG. 5) during the normal transfer and a position of the electrode tab 15a (see A2 in FIG. 6) during the meandering transfer. Accordingly, for example, even during the meandering transfer, at least a portion of the electrode tab may be included in the region of interest, and also the transfer roller may not overlap the region of interest set as above.

As illustrated in FIG. 7, the optical inspection part 130 may be configured as follows. FIG. 7 is a view specifically illustrating the optical inspection part of the inspecting apparatus in FIG. 2.

The optical inspection part 130 may include a lamp 131 provided to emit light toward a unit cell 10′ to be inspected. The lamp 131 may highlight the unit cell 10′ to be inspected so that the camera 133 to be described later clearly photographs the unit cell 10′ to be inspected. The lamp 10 may be a backlight unit. The lamp 10 may be disposed at an upper side of the unit cell 10′ to be inspected. The optical inspection part 130 may include a flat dome 137 to uniformly emit the light onto the unit cell 10′ to be inspected at several angles.

The optical inspection part 130 may include the camera 133 provide to photograph the unit cell 10′ to be inspected in a state in which the light is emitted by the lamp 131. The camera 133 may be a CCD camera. The camera 133 may be disposed at a lower side of the unit cell 10′ to be inspected as opposed to the lamp 131. Due to this arrangement, the unit cell 10′ to be inspected may be disposed between the camera 133 and the lamp 131.

The optical inspection part 130 may include a reflecting plate 135 that changes a photographing path of the camera 133 to a direction perpendicularly crossing the photographing path. The use of the reflecting plate 135 may increase a degree of freedom in position of the camera 133 and also reduce a size in a vertical direction of the inspecting apparatus.

### Embodiment 2

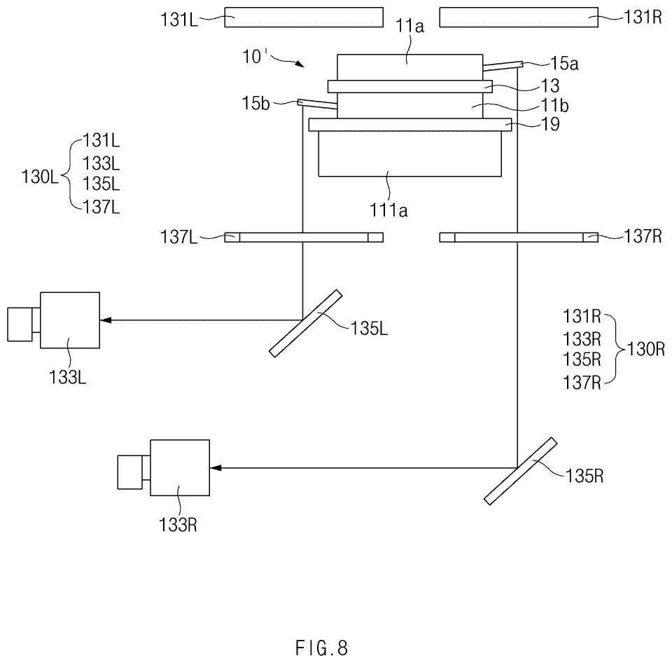

FIG. 8 is a view illustrating an apparatus for inspecting a unit cell according to Embodiment 2 of the present invention. There is a difference from the inspecting apparatus according to Embodiment 1 in that the inspecting apparatus according to Embodiment 2 is provided with two inspection parts. Hereinafter, the description of the inspecting apparatus according to Embodiment 2 will be focused on the difference as above. For reference, the same or similar matters described in Embodiment 1 may apply to Embodiment 2.

In this embodiment, electrode tabs 15a and 15b of a unit cell 10′ to be inspected may include a positive electrode tab and a negative electrode tab extending from a positive electrode and a negative electrode, which one of electrodes 11a and 11b and the other thereof, in the longitudinal direction D2 of an adjacent transfer roller 111a and a direction opposite thereto, respectively. That is, the positive electrode tab and the negative electrode tab may protrude in opposite directions.

An optical inspection part 130 according to this embodiment may include a positive electrode tab inspection part 130L for inspecting the positive electrode tab and a negative electrode tab inspection part 130R for inspecting the negative electrode tab, so as to inspect both the positive electrode tab and the negative electrode tab that protrude in the opposite directions.

The positive electrode tab inspection part 130L may optically inspect the positive electrode tab by setting, as a region of interest R, a region including a region in which at least a portion of the positive electrode tab is disposed at inspection position I. The positive electrode tab inspection part 130L may include a lamp 131L, a flat dome 137L, a reflecting plate 135L, and a camera 133L, which are the same as those described in Embodiment 1.

The negative electrode tab inspection part 130R may optically inspect the negative electrode tab by setting, as the region of interest R, a region including a region in which at least a portion of the negative electrode tab is disposed at the inspection position I. The negative electrode tab inspection part 130R may also include a lamp 131R, a flat dome 137R, a reflecting plate 135R, and a camera 133R, which are the same as those described in Embodiment 1.

The description of the embodiments of the present invention is intended to be illustrative, and various changes and modifications can be made by those of ordinary skill in the art to which the present invention pertains, without departing from the spirit and scope of the present invention as defined by the appended claims.

Therefore, the embodiments set forth herein are to describe the technical spirit of the present invention and not to limit. The scope of the technical spirit of the present invention is not limited by the embodiments.

Moreover, the protective scope of the present invention should be determined by reasonable interpretation of the appended claims and all technical concepts coming within the equivalency range of the present application should be interpreted to be in the scope of the right of the present application.

1. An apparatus for inspecting a unit cell, the apparatus comprising:
a transfer part configured to transfer a plurality of unit cells in a transfer direction, wherein the transfer part comprises a plurality of transfer rollers arranged along the transfer direction, wherein each of the plurality of unit cells has an electrode; and
an optical inspection part configured to optically sense the unit cells when each of the unit cells is disposed at an inspection position along the transfer direction,
wherein each of the plurality of unit cells comprises an electrode tab extending from the respective electrode to an exterior region near a respective separator provided in each of the plurality of unit cells,
wherein the optical inspection part is provided to set a region of interest, wherein the region of interest comprises at least a portion of the respective electrode tab disposed at the inspection position, and
wherein an adjacent transfer roller of the plurality of transfer rollers is disposed adjacent to the region of interest, so as to not overlap the region of interest.

2. The apparatus of claim 1, wherein the region of interest includes a region in which the electrode tab of an inspected one of the unit cells is configured to be disposed at the inspection position during a normal transfer of the unit cells, and wherein the region of interest includes a region in which the electrode tab of the inspected one of the unit cells is configured to be disposed at the inspection position during a misaligned transfer of the unit cell.

3. The apparatus of claim 1, wherein the region of interest comprises a first region and a second region,
wherein the first region extends away from a distal end of the separator of the inspected one of unit cells by a first distance in a longitudinal direction when the inspected one of the unit cells is disposed at the inspection position, wherein an exposure length of the electrode tab of any one of the unit cells is a portion of the respective electrode not enveloped by the respective separator, and
wherein second region extends from the distal end of the separator to an interior region of the separator by a second distance in the longitudinal direction.

4. The apparatus of claim 3, wherein the first distance is greater than or equal to the exposure length of the electrode tab of the inspected one of the unit cells.

5. The apparatus of claim 3, wherein the first distance is in a range of 15 mm to 30 mm.

6. The apparatus of claim 3, wherein the second distance is greater than or equal to the exposure length of the electrode tab of the inspected one of the unit cells, and a predetermined extra distance.

7. The apparatus of claim 3, wherein the second distance is in a range of 15 mm to 30 mm.

8. The apparatus of claim 3, wherein the first distance is less than or equal to the second distance.

9. The apparatus of claim 1, wherein a length of the adjacent transfer roller is less than a length of each of the plurality of transfer rollers, such that the adjacent transfer roller does not overlap with the region of interest.

10. The apparatus of claim 1, wherein the optical inspection part comprises:
a lamp configured to emit light toward an inspected one of the unit cells, wherein the lamp is disposed above the inspected one of the unit cells; and
a camera configured to photograph the inspected one of the unit cells in a state in which the light is emitted by the lamp, wherein the camera is disposed below the inspected one of the unit cells.

11. The apparatus of claim 10, wherein the optical inspection part further comprises a reflecting plate configured to change a photographing path of the camera.

12. The apparatus of claim 1, wherein the electrode tab of each of the unit cells comprises a positive electrode tab and a negative electrode tab extending from a positive electrode and a negative electrode, respectively, in a longitudinal direction transverse to the transfer direction,
wherein the optical inspection part comprises:
a positive electrode tab inspection part configured to optically inspect each of the positive electrode tabs disposed in the region of interest; and
a negative electrode tab inspection part configured to optically inspect each of the negative electrode tabs disposed in the region of interest.

13. The apparatus of claim 1, wherein the adjacent transfer roller is disposed to at least partially overlap an inspected one of the unit cells when the inspected one of the unit cells is disposed at the inspection position.

14. The apparatus of claim 1, wherein a gap between the adjacent transfer roller and immediately adjacent ones of the plurality of transfer rollers is smaller than a width of each of the plurality of unit cells defined in the transfer direction.
